(19) United States
(12) Patent Application Publication
(10) Pub. No.: US 2007/0120763 A1
(43) Pub. Date: May 31, 2007

(54) Display system for viewing multiple video signals

(76) Inventors: Lode De Paepe, Sint - Amandsberg (BE); Tom Kimpe, Gent (BE)

Correspondence Address: BACON & THOMAS, PLLC, 625 SLATERS LANE, FOURTH FLOOR, ALEXANDRIA, VA, 22314, US

(21) Appl. No.: 11/603,065

(22) Filed: Nov. 22, 2006

Related U.S. Application Data
(60) Provisional application No. 60/738,983, filed on Nov. 23, 2005.

(51) Int. Cl. G09G 5/00

(52) U.S. Cl. 345/1.3

(57) ABSTRACT

The present invention provides a method and device for displaying a plurality of video signals on one single display. According to embodiments of the present invention a plurality of display systems can be replaced by one display system being fully backwards compatible without the need to change any software or hardware components such as application software, graphical boards, . . . The present invention can also guarantee that even though a plurality of displays are being replaced by one single display still individual characteristics of those plurality of displays are being retained by the new display.

### CROSS-REFERENCE TO RELATED APPLICATION

This application claims the benefit of provisional application Ser. No. 60/738,983 filed Nov. 23, 2005 under 35 U.S.C. 119(e), the disclosure of which is herein incorporated by reference.

### FIELD OF THE INVENTION

The present invention relates to a system and method for simultaneous viewing of multiple video signals. The invention applies to display systems such as, amongst others, but not limited thereto, plasma display systems, field emission display systems, liquid crystal display systems, electroluminescent (EL) display systems, light emitting diode (LED) and organic light emitting diode (OLED) display systems, especially flat panel display systems used in projection or direct viewing concepts. The invention applies to both monochrome and colour display systems and to emissive, transmissive, reflective and trans-reflective display technologies.

### BACKGROUND OF THE INVENTION

In medical imaging, radiologists typically make use of a display device having two or three displays (PACS (Picture Archiving and Communication System) displays or displays for HIS (Hospital Information System), RIS (Radiology Information System) or EPR (Electronic Patient Record)). Typically two high-resolution displays (1200×1600 or 1536×2048 or 2048×2560 pixels) are connected up, of which one is being used for displaying previous medical images (the prior exam) and the second for displaying the newly acquired medical images (current exam). This group of two displays often is called “a dual-head display device”. Sometimes also a third display is present that typically is a colour display which has lower resolution (1280×1024 or 1024×128 or 1600×1200 or 1200×1600 pixels) and is used to display administrative information such as an electronic patient record, a work list for the radiologist or an application to write a report of a diagnosis.

However, there exist several problems with the above solution. First of all, the fact that two high-resolution displays need to be placed on the work desk is not advantageous since too much place is lost. Moreover also having two separate displays requires separate video cables, power supplies and cables, possibly USB connections to the PC, . . . This all takes extra space and is more expensive because of duplication of components (such as power supply, video cables, . . . ). But the disadvantages are not limited to ergonomic aspects: there are also quality problems when using two separate displays for displaying video signals that are related to each other (such as but not limited to the prior and current exam). In medical imaging displays need to be calibrated. This means that the behaviour of all displays needs to fulfil specific requirements such as, but not limited to, specific shape/absolute values of the luminance curve of the display or specific colour profile for the displays.

An example of a specific luminance curve to be followed is the NEMA DICOM GSDF standard display function that explains what the luminance of the display should be in function of its drive signals (DDL or digital drive level). When using two separate displays there will be problems such as (small) differences in behaviour of the two displays. For example: two displays next to each other could have (slightly) different luminance or colour behaviour (for example colour point) despite calibration. It is also possible that for example there is an inherent quality difference between two displays placed next to each other. For example: it could be that one of the displays has lower inherent contrast ratio or peak luminance or for example a significantly different colour point. In such situations it is very difficult to make the two displays that are placed next to each other “look the same” or in other words make them have the same behaviour. It is exactly such “same behaviour” of displays that is important in medical imaging because this guarantees that medical images will be displayed exactly the same no matter which display system is used. Another disadvantage of using two separate displays is that the images of the two displays are not shown completely next to each other. Since each display has a border (also called bezel) there will be a few centimeter between the two images. In some situations this is a problem since it could lower the sensitivity of the radiologist to perceive subtle image features.

### SUMMARY OF THE INVENTION

An object of the invention is to overcome the disadvantages involved when using a plurality, e.g. two, separate displays in a multi-head, e.g. dual-head, set-up.

The present invention overcomes these disadvantages by combining two or more displays in one single adapted display.

In a first aspect, the present invention provides a method for displaying a plurality of input signals on an active display area of a display. The method comprises:
splitting the active display area in multiple zones, which are preferably non-overlapping,
selecting input signals and assigning these input signals to specific zones of the display, and this for one or more of the zones of the display, and
simultaneously displaying the selected input signals on the display, each in their assigned zone. The selected input signals are simultaneously displayed in their native resolution.

This may be obtained, e.g. for an LCD display system, by using an adapted LCD glass (LCD panel). In other words: instead of having a plurality of, e.g. two, LCD displays with resolution 1200×1600 pixels each and each comprising a LCD panel and driving electronics, the present invention provides a single display system (also called “multi-display”, e.g. “duo-display” in this description) having a single LCD panel of a resolution sufficient to display two images adjacent to each other, e.g. a resolution of at least 2400×1600 pixels or a resolution of at least 1200×3200 pixels, and driving electronics that can drive this adapted panel.

The method according to the first aspect of the present invention may furthermore comprise:
assigning a border pattern to a specific zone of the active display area, and this preferably for one or more of the zones of the active display area, and
displaying this assigned border pattern on the active display area in its assigned zone.

It is known that a border around an image influences the visibility of subtle image features, in particular of such features close to this border. Therefore, assigning a suitable border pattern to a specific zone may improve visibility of subtle image features inside the video signal to be displayed in that zone. It is an advantage of such border that this way perception of quality of the displayed image is improved. In embodiments of the present invention, this border pattern may be a fixed pattern. In alternative embodiments of the present invention, this border pattern may be a dynamic pattern depending on the characteristics or image content of the input signal to be displayed in the same zone of the active display area as where the border is displayed. The border pattern may be dynamically altered based on for example, but not limited thereto, the image content of the video signal to be displayed, the type of image to be displayed, the application that generates the video signals. The border pattern may be adapted, e.g. optimised, to the image content, e.g brightness of the image displayed, to provide improved, e.g. highest possible overall image quality or improved, e.g. highest possible efficiency or performance or work throughput of a user of the display. Highest efficiency or performance of the user means highest possible quality of work delivered by the user of the display or highest possible work throughput of the user of the display.

According to embodiments of the present invention, splitting the active display area in multiple zones may comprise selecting a number of zones and a shape of these zones based on characteristics or image contents of the input signals that are to be displayed. Preferably, an optimal number of zones may be selected, each zone having an optimal shape and/or scaling for displaying the image to be displayed. The shape of the zones and the position of the images may be set so as to be optimal for a particular application. This way, a plurality of images may be automatically and optimally displayed on the active display area. Optimal displaying includes optimizing the aestethical perception and/or optimizing the overall image quality and/or optimizing the efficiency of processing of the image information by a human or machine observer.

According to embodiments of the present invention, selecting input signals and assigning these input signals to specific zones of the active display area, and this for one or more of the zones of the display, comprises optimizing this assigning of input signals in order to obtain improved, e.g. highest possible, overall image quality or improved, e.g. highest possible, efficiency or improved, e.g. highest possible, work throughput of a user of the display. Highest efficiency or performance of the user means highest possible quality of work delivered by the user of the display or highest possible work throughput of the user of the display.

How to perform the splitting of the active display area in multiple zones, or how to select one of the input signals and assign this input signal to a specific zone of the active display area, or how to assign a border pattern to a specific zone of the active display area, may be coded in a signal communicated to the display by a user of the display or by any device or software application. In this case, each of the parameters may be set independently. Alternatively, according to embodiments of the present invention, this information may be selected out of a list stored in non-volatile memory.

In this case, a list of preferred schemes that may e.g. describe scaling, positioning of video signals on the active display area, position and/or shape and/or pattern of borders, may be stored in the non-volatile memory, and a suitable entry may be selected from the list for displaying an image. This selection may be performed automatically by an application controlling the display system, or manually by a user of the display system.

In embodiments of the present invention, displaying an input signal on the display may comprise scaling, filtering, rotating and/or adapting this input signal

In embodiments of the present invention, the method may furthermore comprise adapting characteristics of individual zones of the active display area in order to improve, e.g. maximize, one or more of image quality, user efficiency, user performance or user work throughput. Highest efficiency or performance of the user means highest possible quality of work delivered by the user of the display or highest possible work throughput of the user of the display.

This adapting characteristics of individual zones of the active display area in order to improve, e.g. maximize, image quality or user efficiency or user performance or work throughput of the user may include one or more of changing peak luminance, changing colour point, changing colour profile or changing transfer curve of an individual zone of the active display area. This adapting characteristics of individual zones of the active display area in order to improve, e.g. maximize, image quality or user efficiency or user performance or work throughput of the user may include performing an individual calibration, and thus using different calibration data, for individual zones of the active display area. This way, different zones of the display, corresponding to different image signals to be displayed, can have different calibration tables, so that calibrated colour points or colour profiles for different images to be displayed in different zoned can be retained in a display according to embodiments of the present invention. Performing an individual calibration or using different calibration data for individual zones of the active display area may for example include calibration to DICOM GSDF or using calibration data to comply with DICOM GSDF. This is particularly useful f or medical images.

According to embodiments of the present invention, preferred calibration characteristics for individual zones of the active display area may be coded in a signal communicated to the display by the user of the display or by any device or software application. In this case, each of the parameters may be set independently. Alternatively, according to embodiments of the present invention, this information for individual zones of the active display area may be selected out of a list of calibration parameters stored in non-volatile memory.

According to embodiments of the present invention the duo-display system as described above may be completely backwards compatible with the previous dual-head display system. In other words: one can just plug in the video cables that were driving the previous dual-head display system into the duo-display system and this will work. However, to guarantee this perfect backwards compatibility some problems have to be solved.

In order to obtain backwards compatibility of a display system for use with embodiments of the present invention with a prior art display system. The input signals to be displayed on the active display area of the display are received from a source of input signals, such as e.g. a PC, a workstation, an imaging means or an image generator. The method for displaying a plurality of input signals according to embodiments of the present invention may furthermore comprise emulating multiple instances of a display and sending for each zone a different emulated serial number to the source of the input signals. This way, software applications expecting to send image data to a plurality of displays, will be under the impression that they effectively send their data to the plurality of displays. If two applications, e.g. running on a single PC, are supposed to each send data to a display, in the method according to embodiments of the present invention they will each see only that part of the emulated devices they are supposed to send their data to.

In a second aspect, the present invention provides a display adapted for simultaneously displaying a plurality of input signals encoding images in a native resolution, the display comprising a plurality of input connectors for simultaneously receiving the plurality of input signals, and means for simultaneously displaying the encoded images in their native resolution. The display may be a LCD display, a CRT display, an OLED display or a plasma display.

In a third aspect, the present invention provides a display system comprising a display in accordance with embodiments of the present invention and at least one image source.

The present invention also provides the use of a method according to any of the method embodiments of the present invention in a hospital environment.

In a further aspect, the present invention provides a control unit for a display adapted for displaying a plurality of input signals on an active display area of the display. The control unit comprises
a splitter for splitting the active display area in multiple zones,
a selector for selecting input signals and assigning these input signals to specific zones of the display, and
an image display system for simultaneously displaying the selected input signals on the display, each in their assigned zone.

In another aspect of the present invention a computer program product is provided for executing any of the methods of the invention when executed on a computing device associated with a display. The present invention also includes a machine readable data storage device storing the computer program product. The present invention also includes transmitting the computer program over a wide area or local area network. Particular and preferred aspects of the invention are set out in the accompanying independent and dependent claims. Features from the dependent claims may be combined with features of the independent claims and with features of other dependent claims as appropriate and not merely as explicitly set out in the claims.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

How the present invention may be put into effect will now be described by way of example with reference to the appended drawings, in which:

FIG. 1 shows a triple-head display system in accordance with the prior art.

FIG. 2 shows an embodiment of the invention illustrating a duo-display in schematic form.

FIG. 3 shows examples of mapping 2 virtual displays of size 1200×1600 pixels to one duo-display having 2560×1600 pixels, including a border pattern.

FIG. 4 shows a data transfer mechanism of the prior art.

FIG. 5 shows a data transfer mechanism in accordance with embodiments of the present invention.

FIG. 6 shows some examples of optimal positioning and scaling of video inputs on a duo-display in accordance with embodiments of the present invention.

FIG. 7 shows different colour point or colour profile for different zones of the active display area of a duo-display in accordance with embodiments of the present invention.

FIG. 8 shows different peak luminance for different zones of the display area in a duo-display in accordance with embodiments of the present invention.

FIG. 9 shows spatial modulation of backlight characteristics in accordance with embodiments of the present invention.

FIG. 10 shows optimal sensor location for calibration in accordance with embodiments of the present invention.

FIG. 11 shows copy of images between different zones of the display system in accordance with embodiments of the present invention.

FIG. 12 shows the need for dynamic serial numbers in a duo-display in accordance with embodiments of the present invention.

FIG. 13 shows connecting of input devices on a duo-display in accordance with embodiments of the present invention.

FIG. 14 shows translation mechanisms for coordinates of input devices for a multi-display in accordance with embodiments of the present invention

In the different figures, the same reference signs refer to the same or analogous elements.

### DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. Where the term “comprising” is used in the present description and claims, it does not exclude other elements or steps.

It should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

The invention will now be described by a detailed description of several embodiments of the invention. It is clear that other embodiments of the invention can be configured according to the knowledge of persons skilled in the art without departing from the true spirit or technical teaching of the invention, the invention being limited only by the terms of the appended claims.

General concept of the present invention

According to the present invention a plurality (two or more) displays will be replaced by a novel, single display (in the following called “duo-display” in case the single display is intended to replace two displays, or more generally “multi-display”) comprising one single display system or panel, e.g. a plasma display system, a projection panel of a DMD, an OLED panel, an LCD panel, a CRT tube, that is able to display simultaneously the video signals intended to be displayed originally on this plurality of displays. This new display system or panel according to the present invention will preferably have a resolution so that this multi-display, e.g. duo-display, at least can display in real-size (without scaling down) the plurality of, e.g. two, video signals of the display systems that this multi-display, e.g. duo-display replaces.

A few possible resolutions will be described as an example but are not limiting in any way the scope of the present invention. Once could replace two 2 Mega Pixel display systems of resolution 1200×1600 pixels by one new (possibly custom) display system that has resolution of at least 2400×1600 pixels (if the two video signals of size 1200×1600 pixels will be placed horizontally next to each other) or at least 1600×2400 pixels (if the two video signals of size 1200×1600 pixels will be placed vertically above each other). Therefore possible resolution for this duo-display system could be for example, but not limited thereto, 2400×1600 pixels, 2560×1600 pixels, 3200×1600 pixels, 2400×1700 pixels, 2560×1700 pixels, . . . In case the two 1200×1600 pixel video signals would be placed above each other then the resolution of the new display system or panel could be for example but not limited to 1600×2400 pixels, 1600×2560 pixels, 1600×3200 pixels, 1700×2400 pixels, 1700×2560 pixels, . . . In other words: it is preferable that the new panel resolution will allow to display the video signals of the plurality (two, three, four, . . . or more) of displays that it is replacing in native resolution (not scaled down) and simultaneously.

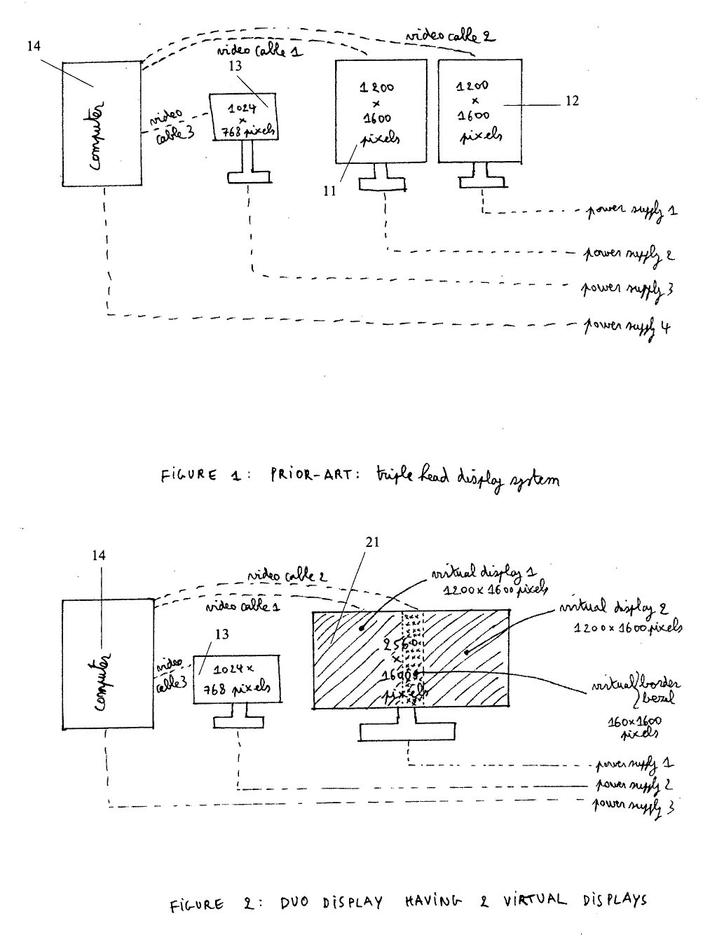

FIG. 1 shows the prior art situation of a dual-head high resolution display 11, 12 and a third colour display 13. With “high resolution” is meant having a resolution larger than 2 Mpixels. Both high resolution displays 11, 12, as well as the colour display 13 are connected to a source of input signals 14, e.g. a workstation or a PC or an image capturing device or an image generator.

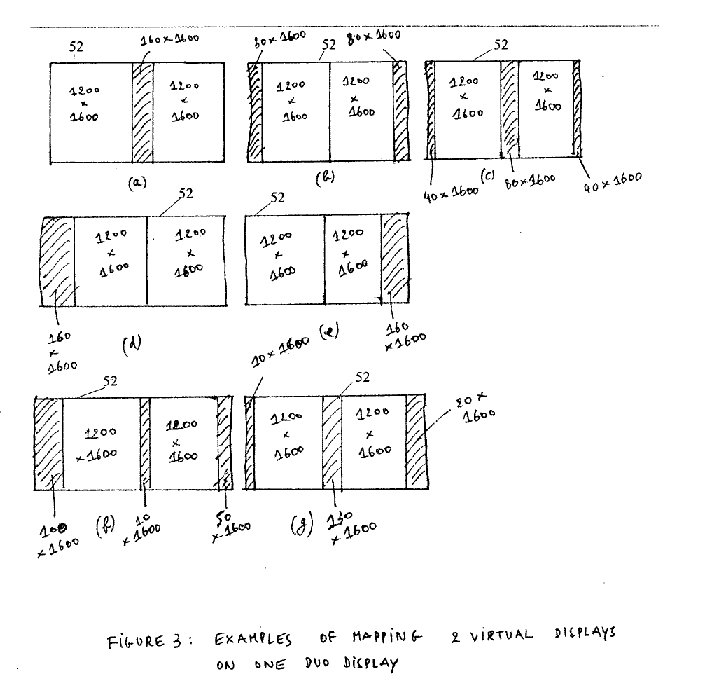

FIG. 2 shows an embodiment according to the present invention where the two high resolution displays 11, 12 have been replaced by a duo-display 21 in accordance with embodiments of the present invention that is able to display the two video signals of the two replaced high resolution displays 11, 12 in native resolution and simultaneously.

In FIGS. 1 and 2 the two high resolution displays 11, 12 that were replaced by the duo-display 21 were of resolution two Mega Pixel (1200×1600 pixels). This specific resolution is, however, not a limitation of the present invention. For example: it is not a requirement that the display systems that are being replaced by the duo display system of the present invention all have the same resolution or even aspect ratio. According to embodiments of the present invention it would also be possible to replace for example three display systems of resolutions 1200×1600 pixels, 1536×2048 pixels and 1024×768 pixels by one multi-display system of resolution at least 3760×2048 pixels. It is to be noted from FIG. 1 and FIG. 2 that the present invention (FIG. 2) will provide perfect backwards compatibility with the prior-art (FIG. 1) situation, by providing two inputs on the duo-display, so that the input signals from the source of input signals can be connected up to the multi-display 21 as they could be connected up to the original displays 11, 12. One can just replace the two high resolution displays 11, 12 of FIG. 1 with the duo-display 21 of the present invention and this without having to replace the source of input signals 14, e.g. PC (workstation) or the graphical boards inside the workstation, nor the video cables. Also it is to be noted from FIG. 2 that the present invention requires less power supplies or power cables (one per display). Also compared to the prior art situation (FIG. 1) the present invention will allow a more cost-effective display device since it is not required anymore that parts of the display device are replicated. Indeed: in the prior art situation (FIG. 1) one needs two power supplies, two interface boards (one electronic board inside each of the two displays 11, 12 to drive the panel of each of the two displays 11, 12), two backlights . . . .

Compatibllity Aspects

It is to be noted that to provide full backwards compatibility between the multi-display according to embodiments of the present invention and the multiple independent displays as used in the prior art, the multi-display 21, e.g. duo display, (according to embodiments of the present invention) needs to have the exact same functionality and behave exactly the same as the plurality of, e.g. two, separate displays 11, 12. To achieve this full backwards compatibility several changes and improvements are needed. These changes and improvements are described here and are also part of the present invention.

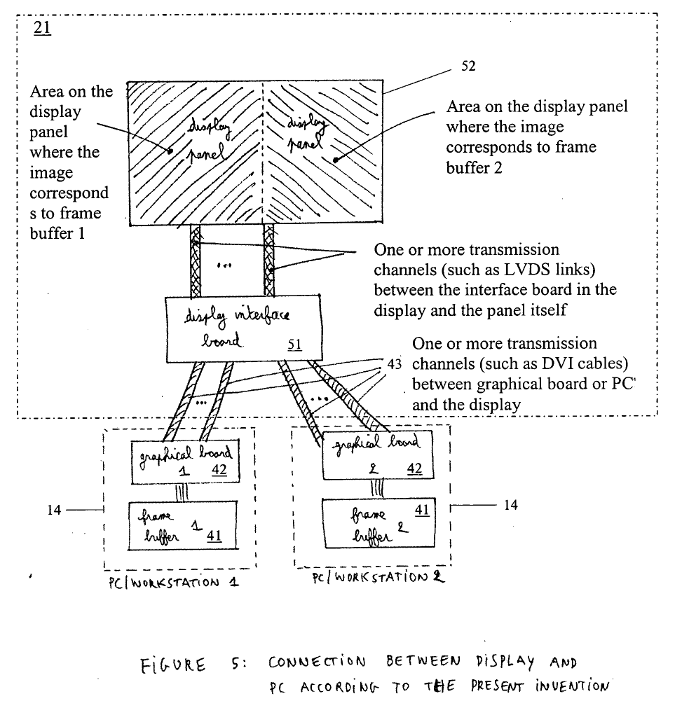

A first aspect that needs to be adapted compared to a standard display device is the logical dividing of the video link. FIG. 4 shows the prior-art situation: up to today it was always the case that an image in a frame buffer 41 of a source 14 of input images was being processed and then sent by the graphical board 42 of that source 14 of input images to the display 11. Multiple transmission channels 43 are possible for the link between graphical board 42 (or PC) and the display 11: examples are DVI (Digital Visual Interface) link, DPVL (Digital Packet Video Link), analogue RGB links, display port link, . . . Making the link in practice means connecting one or more cables between PC 14 or graphical board 42 thereof on the one hand and the display 11 on the other hand (although also wireless links are possible, in that case connecting one or more cables should be replaced by setting up one or more wireless connections between graphical board 42 of PC 14 and display 11). Once the signal arrived at the interface board 44 (driver board) inside the display 11 then this interface board 44 drives the actual display system or panel 45 (LCD, plasma, OLED, . . . ) appropriately. A very important characteristic of the prior-art situation is that the interface board 44 receives data from one single image source 14 and tries to display that source of information as good as possible on the display panel 45 and thus on the display 11. This could involve scaling or positioning this signal correctly. According to the prior-art situation: if one would like to display multiple image sources on one and the same display system or panel then these multiple image sources would already need to be combined in the frame buffer 41 of the graphical board 42 of the image source 14. For example: if according to the prior-art one would like to display two different image signals on one display panel 45 then one would have to build a special (non standard) graphical board 42 that combines the two image signals and then sends the combined signal to the display system or panel 45. For the display system or panel 45 this signal then would look as a normal signal. In practice one often uses special frame grabber boards that are placed inside the PC 14 to capture an external signal. This external system is then copied or combined in some way with the contents of the frame buffer 41 of the graphical board 42 that is also in the PC 14. This combined image then is sent by the graphical board 42 to the display system or panel 45 of the display 11. Disadvantage of this prior-art is that non-standard hardware is required. Indeed: if one would have two workstations 14 each providing a video output and if one needs to display these two outputs simultaneously on one display system or panel 45 , then one needs special hardware to combine these two video signals before the signals are sent to this single display system or panel 45.

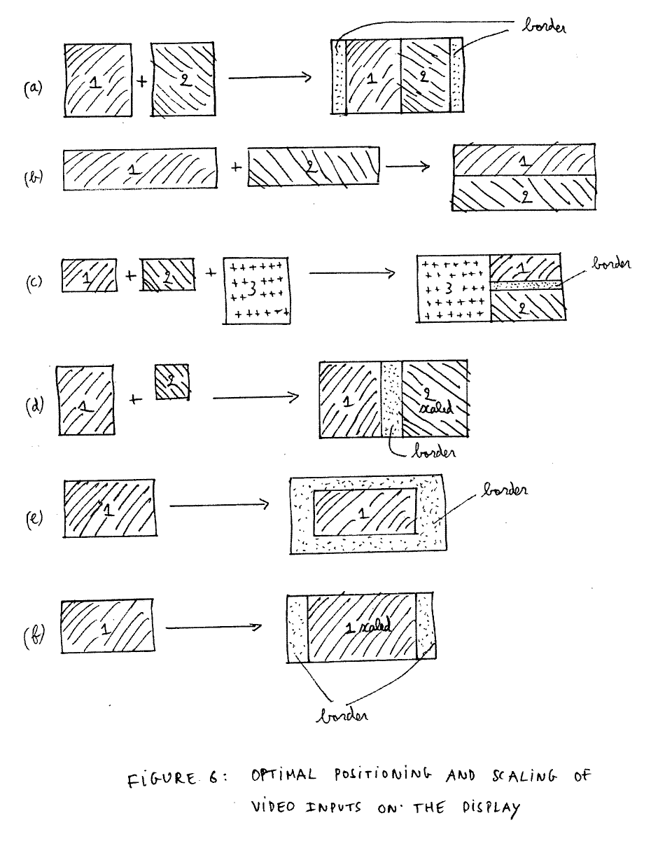

FIG. 5 shows the image transfer mechanism in accordance with embodiments of the present invention. The display 21 according to embodiments of the present invention now has the new functionality of having multiple independent video (image) inputs and combining these video inputs in an optimal way in the display interface board 51 before sending the combined video signal to the display system or panel 52. For clarity one specific example is given but this does not limit the present invention in any way. One could have two workstations 14 each comprising a graphical board 42 that generates a 2 Mega Pixel resolution (1200×1600pixels) image and connected with 2 DVI cables 43 (one for each display 11, 12) to two separate displays 11, 12: one display 11 shows the first 2 Mega Pixel signal and the second display 12 shows the second 2 mega Pixel signal. According to embodiments of the present invention it would be possible to just replace the two displays 11, 12 by the duo display 21 in accordance with embodiments of the present invention. There would be no need to replace the graphical boards 42 in the workstations 14 or to add extra hardware. The two DVI cables 43 each carrying a two Mega Pixel video signal would be connected to the duo-display 21 (called duo-display since it replaces two displays, but more generally multi-display). This duo-display 21 would take in the video signals of both workstations 14, process these two video signals on the interface board 51 inside the duo-display 21, and then send the optimized and combined video signal to the display panel 52 so that one video signal is shown in one zone e.g. on the left side of the duo-display panel 52 and the other video signal is shown in another zone, e.g. on the right side of the duo-display panel 52.

It is to be noted that lots of variants are possible such as but not limited to: placing more than one graphical board 42 in an image source 14, e.g. PC/workstation, and providing video signals from such plurality of graphical boards 42 of one image source 14 to one duo display 21, placing a single graphical board in an image source 14, e.g. PC/Workstation, that can output more than one video signal (for instance a “dual head” graphical board that can provide two simultaneous video outputs out) and provide these multiple video inputs to the duo display 21, providing more than two image signals to the duo display 21 and moreover these video signals do not need to be of same resolution, aspect ratio, color or greyscale depth, frame rate (refresh rate), encoding mechanism (DVI, DPVL, analogue RGB, display port, . . . ) . . . The basic idea is that the multi-display system 21 itself is able to combine multiple video signals, e.g. in its display interface board 51, and drive one display system or panel 52 to optimally display those multiple video signals simultaneously.

However several other problems have to be solved in case it should be possible to just replace a plurality of displays 11, 12 by one single display 21 that can display simultaneously all of the video signals intended to be displayed on this plurality of displays 11, 12. This is especially true because in most situations the device or devices 14 that generate the video signals are expecting separate individual displays 11, 12 and not one single display 21 that replaces all these displays 11, 12. In the following paragraph several of those problems and solutions according to embodiments of the present invention will be explained.

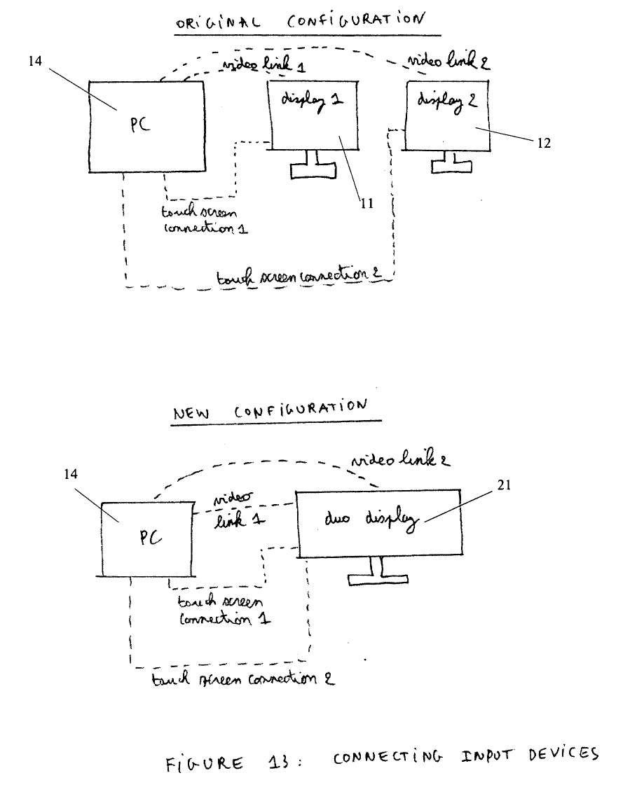

A first problem is that in most situations each display 11, 12 has a unique serial number. When multiple displays 11, 12 are being replaced by one new multi-display, e.g. duo-display 21, then requests for the serial number (requests could come for example from a software application or from any other device, user or machine) could result into problems. This is illustrated in FIG. 12: a PC 14 comprises a graphical board 42 with two video outputs. On the PC 14 runs a viewing application that requests the serial number of each of the displays 11, 12 connected to each of the two video links. A possible reason is that the application wants to make sure that a display is attached to each of the links. In the original configuration the application will receive two different serial numbers, in this situation e.g. 111 and 112 for the displays 11, 12 connected to video link one and two respectively. However, in the new configuration where the two displays 11, 12 are replaced by one duo-display 21, the application would normally receive twice the same serial number, e.g. 111. This could cause the application to crash or exit since this would mean that the one single display 21 (the duo-display) is attached to the two video links of the graphical board 42 at the same time. Since the graphical board 42 does normally not support such a situation (it is to be remembered that backwards compatibility is desired) this could result into errors. According to embodiments of the present invention the duo-display 21 will answer with a different serial number on the two video links. An example could be that the duo-display 21 answers e.g. with serial number 222a on video link one and with serial number 222b on video link two. By doing so, existing applications that don't know the concept of multi-displays, e.g. duo-displays 21 will still function correctly and at the same time newer applications that do know the concept of multi-displays, e.g. duo-displays 21, will be able to detect that it is one and the same display 21 that is hooked up to video links one and two. The reason that these applications can detect that it is one and the same display 21 is because these applications are programmed to know the connection (systematic link) between the serial numbers communicated on link one and link two. As an example only, the systematic link between the serial numbers of one multi-display on different video links could always be multiples of 13. Of course other possibilities for serial numbers that the multi-display, e.g; duo-display 21 communicates are possible, the only requirement is that it should be possible for a software application to detect that the plurality of, e.g. two, communicated serial numbers, although different, belong to one and the same display 21. As a variant the multi-display, e.g. duo-display 21, could be programmed to only communicate a plurality of, e.g. two, serial numbers if the display 21 will be used as replacement where backwards compatibility is necessary. If backwards compatibility is not necessary the display 21 could just communicate one and the same serial number on all of its links. In other words: based on the situation the display 21 will identify itself as having one or multiple serial numbers or in other words will identify itself as being one display or being multiple displays. In summary: the multi-display, e.g. duo-display, has the capability of dynamically altering its serial numbers(s).

A second problem is about the automatic detection of capabilities of the display by means of, for instance but not limited to, EDID (Extended Display Identification Data) from VESA (Video Electronic Standards Association) or alternatives provided by DPVL (Digital Packet Video Link), packet link or display port. What typically happens if a display 11 is connected to a graphical board 42 is that there is some kind of negotiation between display 11 and graphical board 42 on which scan the graphical board 42 will send to the display 11. In case of EDID for example, the graphical board 42 will read out a data structure from the display 11. This data structure describes which scans (resolution, colour depth, refresh rate, scan timings, blanking timings . . . ) the display 11 supports. There is also the possibility of indicating preferred scans or preferred timings which the graphical board 42 may follow if it is capable of doing so. Based on that list of supported scans and the capabilities of the graphical board 42 itself the graphical board 42 will decide on a specific scan that will be used to transmit data to the display 11. However, with the new multi-display, e.g. duo-display 21, there is no real list of supported scans or preferred scans. Indeed, since the multi-display, e.g. duo display 21, has multiple inputs and since the display 21 supports multiple scans at each of those inputs it is not feasible anymore to use a fixed EDID data structure inside the display 21. The problem will be described by some examples but the present invention is not limited by those examples. Suppose that two displays 11, 12 of resolution 2 Mega Pixel (1200×1600 pixels) each are being replaced by a duo-display 21 of resolution 2560×1600 pixels. This duo-display 21 therefore has two input signals that are both of resolution 1200x1600 pixels. In this situation there are at least three possibilities for the preferred scan of the duo-display 21. A first possibility is that the duo-display 21 communicates 2560×1600 pixels as preferred scan on both of the video links since this is the native resolution of the display system or panel 52 as a unit. A second possibility is that the display 21 communicates a preferred scan of 1200×1600 pixels on both of the video links since each of those links indeed is intended to transport this resolution in case of replacement of a dual head 1200×1600 pixels system 11, 12. A third possible solution is that the display 21 communicates preferred scan of 1280×1600 pixels on both of the video links since the display indeed is capable of displaying in native resolution two signals of resolution 1280×1600pixels simultaneously. Apart from these choices there are many other possibilities when one realizes that the display 21 could also do up or down scaling of the incoming video signal. The problem now is that if the display 21 communicates a non-optimal (preferred) scan to the graphical board 42 that then the graphical board 42 will supply this scan if possible without knowing that it is sub-optimal. Therefore following solution is provided by embodiments of the present invention. The display 21 can iteratively try out other preferred scans by dynamically changing the contents of its EDID (or similar data structure with similar function). Indeed, each time the graphical board 42 detects that a new display is connected to the video link then the graphical board 42 will read out again the EDID and adapt its scan if needed. In EDID there is a possibility for the display to force the graphical board 42 to read out the EDID. This can be done by changing the state of the “hot-swap” pin. The hot swap pin is a signal (electrical line) that is part of the video cable and that indicates whether or not a display is connected to the link. This indication is by putting this “hot-swap” line to a specific voltage. One voltage indicates that a display is connected and another voltage indicates that no display is connected. When no display is connected and the cable is therefore not connected to any device, then the voltage of the “hot-swap” pin will be that voltage that indicates that no display is present. However, as soon as a display is connected the voltage of the “hot-swap” pin is forced by the display (or display connector) to the voltage indicating that a display is present. The transition on the “hot-swap” pin from “no display present” to “display present” will cause the graphical board 42 to read out the EDID of the display and adapt the timing/scan if needed. Now, the multi-display, e.g. duo-display 21, can have a list of multiple EDIDs stored inside the display 21. One of the EDIDs out of that list will be the optimal combination of graphical board 42 that will be connected to the display 21 and the display 21 itself. However, since the display 21 cannot read out the capabilities of the graphical board 42 the display 21 cannot know which one is the best EDID. The multi-display, e.g. duo-display 21, therefore will take an EDID out of the list and provide this EDID to the graphical board 42 when requested (this will take place as soon as the display 21 is connected to the graphical board 42). The display 21 now can detect whether the graphical board 42 is able to provide the preferred scan/timing that was in that EDID. As a second step the multi-display, e.g. duo-display 21, will force a change to the state of the “hot-swap” signal even though the video cable remains connected. Therefore the graphical board 42 gets a signal that there is no display connected anymore. Shortly afterwards the display 21 will change the EDID to the next EDID out of the list stored in the display 21 and will again force a change on the “hot-swap” signal. This will cause the graphical board 42 to detect that again a display 21 is connected. Therefore the graphical board 42 will read out the EDID and provide the preferred scan/timing to the display 21 if possible. In this way all EDIDs out of the EDID list in the display 21 can be tried out and the display 21 itself can find out the capabilities of the graphical board 42. In this way the display 21 can communicate the best scan that both the display 21 and graphical board 42 can provide even though according to the EDID standard the display 21 cannot find out what the capabilities of the graphical board 42 are. Of course the display 21 could remember which EDIDs out of the list have been used in the past so that these ones can be selected/tried first. This will save time because fewer configurations will have to be tried out. Alternatively the display 21 does not have to store a list of EDIDs but could dynamically create those EDIDs as needed. For example: a display 21 could start with an EDID describing the highest resolution the display 21 can handle, if the graphical board 42 cannot provide this resolution it will (most likely) switch to a safe resolution such as VGA and the display 21 will notice that the graphical board 42 cannot provide this resolution. Therefore the display 21 then could change its EDID to describe lower resolution, test again if the graphical board 42 can provide this resolution and so on . . . . Alternatively, the display 21 could make/let the user or any other software application or any other device select the EDID that the display 21 will communicate on each of its display links.

According to another aspect of the present invention the multi-display, e.g. duo display 21, is able to frame lock the multiple input video signals if desired. Indeed, at its multiple inputs it is not necessarily the case that the refresh rates of these inputs are equal (the same frequency) and in phase (a new frame starts at the same time on all of the inputs). However sometimes it is required that this video data is displayed synchronously on the multi-display, e.g; duo-display. Therefore the multi-display, e.g. duo-display can double buffer or triple buffer the incoming video signals and read out these buffers synchronously. In this way it is possible to avoid any breaking up or tearing artefacts. However this is only possible if the refresh rate of the different signals is the same although there can be a possible phase difference. If the refresh rate of the different signals is an exact multiple of each other then this technique can also be used. In other situations the display 21 might have to do frame rate conversion. For example: if the two display inputs have 50 Hz and 60 Hz respectively then the display electronics could send data to the display system or panel 52 at a refresh rate of 60 Hz. This will require however that for the 50 Hz signal some frame duplication takes place or that using some algorithm intermediate frames are being created (in other words that the 50 Hz signal is converted to a 60 Hz signal). For some future display systems or panels 52 there might be the possibility to provide different zones of the display system or panel 52 with a different scan (refresh rate, blanking, timings). If such a display system or panel 52 were used then the multi-display, e.g. duo-display could of course drive different zones of the display system or panel 52 differently depending on the respective video signals those zones correspond to.

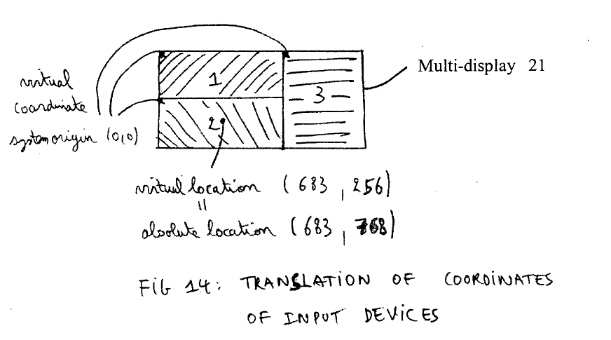

According to yet another aspect of the present invention the multi-display, e.g; duo-display can translate signals of input devices such as but not limited to mice, joy sticks, touch screens, cameras or eye/gaze tracking devices, gesture recognition devices or any other devices that provide as result the position of an object on the active display area. Reference is made to FIG. 13 for the following description. Suppose a touch screen is integrated in the multi-display, e.g. duo-display 21. Also suppose that the multi-display, e.g. duo display 21 is being used as a replacement for a plurality of displays, e.g. two displays 11, 12 (for example: one duo-display 21 with resolution 2560×1600 pixels replaces two displays 11, 12 with resolution 1200×1600 pixels). In that situation the duo-display 21 will have two video inputs. If the two displays 11, 12 have some input device such as e.g. a touch screen then each of the two displays 11, 12 will also have a connection to transfer input device data between PC 14 and the display 11, 12. Such connection could be for example but not limited to: a USB connection, a fire wire connection, a serial connection, a RS232 connection, a three-wire connection, a two-wire connection or any other transmission link that connects the touch screen with the PC 14. In the situation where a duo-display 21 replaces two individual displays 11, 12 however, the PC 14 also expects two touch screen connections since it thinks that to separate display s 11, 12 (with two separate touch panels) are connected to the video links. The duo-display 21, however, will most likely only have a single touch screen that covers the complete active display area both because of cost reasons and image quality reasons. Therefore the duo-display 21 will have to emulate two individual touch screens (alternatively: a software program running on the host PC/workstation 14 or on multiple host PCs/workstations 14 could perform this emulation). In other words: the duo-display 21 will have to convert signals/communication from the single physical touch screen into signals/communication of two virtual touch screens. Of course also coordinate conversion will be required (translating from coordinates in one space (being the complete touch screen) into coordinates for the respective two virtual touch screens in two spaces being the respective zones of the touch screen corresponding to the virtual displays). For example: a multi-display, e.g. duo-display 21, could translate the coordinates of the touch screen so that the total touch screen area is divided into multiple smaller touch screen areas, each area having its own coordinate system starting for example with (0,0) on the left-upper zone of that area. The multi-display 21 only sends touch screen coordinates to the devices 14 of which the video output corresponds to the touch screen area where the coordinates belong to. See also FIG. 14: a multi-display contains several virtual displays (1, 2 and 3). The multi-display 21 has a touch screen over its complete active display area with one coordinate system that goes from (0,0) at the upper left corner to for example (2048, 1023) at the lower right comer. However, the multi-display will perform coordinate translation such that a touch coordinate will be translated into a new coordinate. There will be three new coordinate systems corresponding to the three virtual displays 1, 2 and 3. Each of the three coordinate systems have origin (0,0) in the upper left of the virtual display 1, 2, 3 to which they belong. For example: absolute touch screen location (1024, 0) in this situation would be translated to virtual touch screen location (0,0) and communicated to the device generating (or connected to the device generating) the video output for virtual display 3. Another example: absolute location (683, 768) would be translated into virtual location (683, 256) and communicated to the device generating video signal 2. The above description was given with touch panels as an example but the present invention of course also covers any other input device. Also the above description was given with two or three video inputs as example but of course the present invention also covers more video inputs in which case more than two or three virtual touch screens will have to be emulated. In the example in FIG. 13 both video links are from one source 14 of image data, e.g. PC, this is of course also not a limitation of the present invention. These two or three links could also come from different sources 14 of image data, e.g. devices such as PCs or other image sources. The same principle of emulating virtual devices also holds for any other type of devices such as but not limited to luminance and/or colour sensors, temperature sensors, display buttons or interfaces, . . . For example: in case a duo-display 21 replaces two displays 11, 12 that each have a luminance sensor and if the duo-display 21 only has one such luminance sensor, then the duo-display 21 will have to emulate a virtual luminance sensor for each of the two video links connected to the duo-display 21. This is necessary because for backwards compatibility reasons the PC 14 could be expecting exactly one dedicated/individual luminance sensor per display.

According to another aspect of the present invention the multi-display 21 will automatically display a video signal or combination of video signals in highest possible quality. This could mean that a video signal is automatically displayed at the centre of the active display area of the multi-display 21 in case this video signal is the only one that is connected. Another possibility is that the multi-display 21 discovers in some way (for instance by querying the sources 14 that are generating the video data) what the optimal relative positioning of the images on the active display area of the multi-display 21 would be. Then the multi-display 21 could automatically set up the relative location and size of these video signals on the multi-display 21 as to resemble the optimal configuration as good as possible. An example could be when the multi-display 21, e.g. duo-display replaces two displays 11, 12 that are being used as a dual-head setup. In other words: two displays 11, 12 that are located next to each other and connected to one single image source 14, e.g. PC, are being replaced by a duo-display 21. In such a situation the duo-display 21 could discover which video signal corresponds to the left and right respectively and automatically display this left video signal on the left of the active display area of the duo-display 21 and the right video signal on the right of the active display area of the duo-display 21.

According to another aspect of the present invention the multi-display 21 could also be driven at its full resolution even if the graphical board or graphical boards 42 driving the multi-display 21 normally does not support this resolution. For example: if one has a duo-display 21 of resolution 2560×1600 pixels and this duo-display 21 has two video inputs. If one also has a graphical board 42 with two video outputs that can each provide maximal resolution 1280×1600 pixels. Then one has a plurality of possibilities to drive the duo-display 21 at its full resolution (2560×1600 pixels) and at the same time perceiving the display 21 as one unit (so not two different displays 11, 12 of lower resolution). One possibility is to use a software program on the PC 14 (such as, but not limited to, a filter driver) that simulates one large frame buffer 41 of size 2560×1600 pixels and then maps/distributes this frame buffer 41 over the two video links 43 of the graphical board 42. Each of those links 43 then can transport 1280×1600 pixels. Another possibility is to use again such a software program at the PC side but transfer all pixel data over one single video link 43 (in which case only one cable needs to be connected to the display 21). Since the graphical board 42 normally does not support such high resolution at full frame rate one could reduce the frame rate until sufficient bandwidth on the link 43 is available. One solution in this case would be to send frames of resolution 1280×1600 pixels over the link 43 where out of two frames one frame corresponds to the left part of the 2560×1600 pixel frame buffer 41 and the other frame corresponds to the right part of this 2560×1600 frame buffer 41. The display 21 and/or graphical board 42 could dynamically detect these possibilities described above, select between them dynamically and use them as needed and available. It is to be noted that when using the filter driver approach the inverse mechanism is also possible: simulating two separate displays (for example but not limited to resolution 1600×1200 pixels) while the graphical board has a frame buffer of size for example but not limited to 2560×1600 pixels and also sending this scan to the duo-display 21 that acts as one display having resolution 2560×1600 pixels.

According to another aspect of the present invention the multi-display can also work with video transmission protocols that are packet-based such as, but not limited to, DPVL packet link or display port. In that situation only one physical link might be connected to the multi-display but that link can carry video signals of more than one display. The multi-display will then appropriately grab from this link the video data that is relevant for each of the zones.

According to yet another aspect of the present invention the multi-display handles the situation that one or more devices are connected, e.g. by USB, alternatively by firewire, alternatively by three-wire, alternatively by two-wire, alternatively by RS232, alternatively by any other suitable protocol, to the multi-display 21 while the multi-display 21 itself is connected by the video links 43 to two or more sources 14 of input data, e.g. devices such as, but not limited to, PCs or workstations. In this situation the multi-display 21 will be programmed to decide whether each of these devices attached to the multi-display 21 will be made visible to none or only one or to a chosen set of the sources 14 of input data, e.g. PCs/workstations. In case a specific device is made visible to more than one source 14 of input data, e.g. PC or workstation, connected to the multi-display 21 then it might be necessary that again the multi-display 21 simulates virtual devices in order to be compatible with a protocol standard. This simulating of virtual devices is however not a requirement. For example: if a mass storage device such as a USB hard drive is connected to the multi-display 21 then this hard drive may be made visible to only one or to multiple of the sources 14 of image data, e.g. PCs connected to the multi-display 21. In case the hard drive is made visible to more than one source 14 of image data, e.g. PC or workstation then there is still the choice on whether to simulate a virtual USB hard drive for each of the sources 14 of image data, e.g. PCs/workstations, or to share in some way this USB hard drive between the different sources 14 of image data, e.g. PCs or workstations.

Ergonomic Aspects

The present invention also describes improvements, possibly optimizations, to ergonomic aspects.

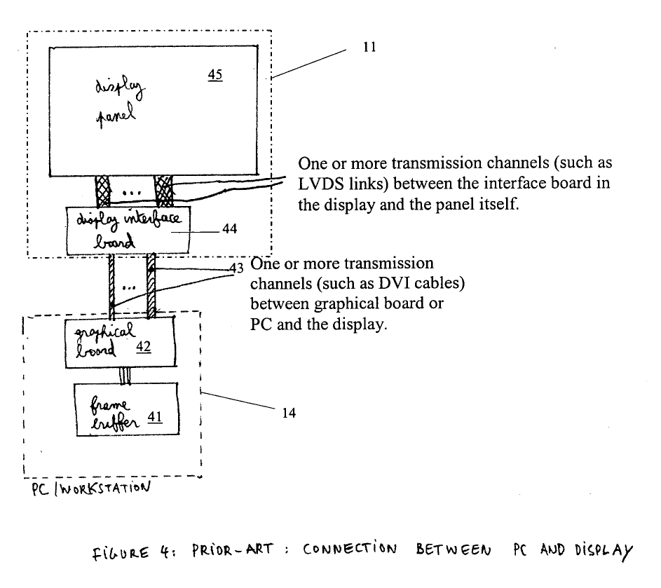

A first aspect is the improved, e.g. optimal, positioning of the plurality (two or more) of video signals that are being displayed on the multi-display system 21. In case the resolution of the multi-display system 21 is strictly larger than the sum of the resolutions of the plurality of video signals to be simultaneously displayed then multiple positions for the plurality of video signals are possible on the active display area 21 of the multi-display system 21. FIG. 3 gives examples of several possibilities. In this situation, as an example only, a display system or panel 52 of resolution 2560×1600 pixels is being used to display two video signals of resolution 1200×1600 simultaneously. Someone skilled in the art will immediately understand that there are multiple possibilities to map the two “virtual video signals” or “virtual displays” of resolution 1200×1600 pixels onto the active display area of the multi-display 21 with resolution 2560×1600 pixels. Without limiting the present invention a number of examples are given: centering the images corresponding to the two video signals on the active display area directly next to each other (configuration (b) in FIG. 3) or placing the images corresponding to the two video signals adjacent each other to one side of the active display area (configuration (d) or (e) in FIG. 3), leaving a border (a zone of the panel of which the pixels are not driven directly with one of the two video signals but for instance driven as completely black or at some grey or colour value) in between the images corresponding to the two video signals (configuration (a) in FIG. 3), leaving both a border in between the images corresponding to the video signals and at the left and right edge of the active display area (configuration (c), (f) or (g) in FIG. 3), . . . It is to be noted that although in FIG. 3 the borders are always placed on the left and the right of the images corresponding to the video signals (in other words: there is no border above and below the images corresponding to the video signals) this is not a limitation of the present invention. According to embodiments of the present invention it is also possible to have borders above and below the images corresponding to the video signals, and/or to the left and the right of the images corresponding to the video signals, and/or in between the images corresponding to the video signals, . . . or according to any suitable combination depending on the resolution of the individual images with respect to the resolution of the multi-display 21. It is also not a requirement that the borders have a rectangular shape, all possible shapes are possible as will be obvious for someone skilled in the art.

Some studies suggest that the colour of the border or separation between two image signals has an influence on the perception of the images corresponding to the two video signals. For example: if one has two separate displays 11, 12 put next to each other then there will be a border or bezel in between the two images displayed on the respective displays 11, 12. It is known that the colour of this bezel (for example black or silver or grey) influences the visibility of subtle image features close to this border. Therefore according to embodiments of the present invention the multi-display 21 can have improved, e.g. optimized, location, size, shape and pattern (grey or colour value or specific pixel pattern assigned to pixels in the border area of the display system or panel 54) of the border or borders such that the user of the display 21 will perceive the display 21 as having high quality or being aesthetically pleasant or such that the visibility of subtle image features inside the images corresponding to the video signals is optimized. It is possible to assign to different borders different shape and/or patterns.

According to embodiments of the present invention the location, size, shape and/or pattern of the border or borders can be dynamically altered based on, for example but not limited thereto: the image contents of one or more video signals being displayed, the type of images or video being encoded in one or more of the video signals, the particular user that is working with the display 21, the particular application or applications that generate one or more of the video signals, the luminance intensity and colour point of the ambient light in the room, the colour and/or shape of the bezel around the multi-display 21, . . . According to embodiments of the present invention the display 21 can be programmed to select the particular location, size, shape and pattern of the border or borders based on a table that is stored inside the display 21. The user or the application or applications generating the video data can then manually select a preference out of this table and/or add a new preference to this table. Alternatively a particular scheme out of this table can be selected based on for example but not limited to: the image contents of one or more video signals being displayed, the type of images or video being encoded in one or more of the video signals, the particular user that is working with the display 21, the particular application or applications that generate one or more of the video signals, the luminance intensity and colour point of the ambient light in the room, the colour and/or shape of the bezel around the multi-display 21, . . . Alternatively a particular scheme out of this table can be selected based on the particular scan (resolution and/or colour depth and/or refresh rate) of one or more of the video signals connected/transmitted to the display 21.

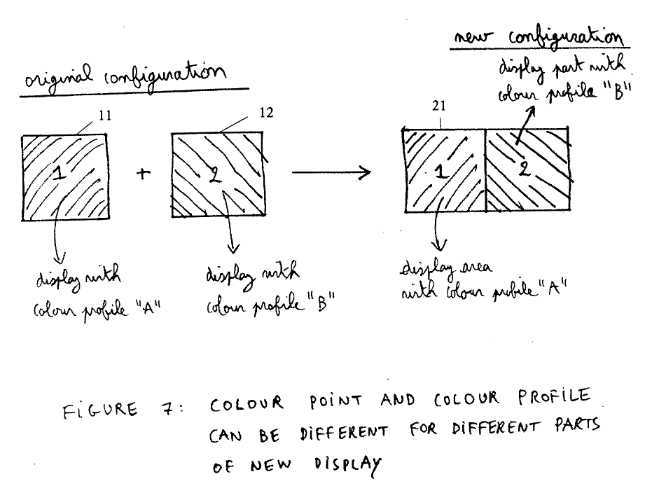

According to another aspect of the present invention the multi-display 21 may also be adapted to automatically scale (up scaling or down scaling) the images of zero, one or more of the video inputs and automatically change the position of the individual (scaled) video signals on the active display area of the display system or panel 54 in order to improve, e.g. optimize, the aesthetical perception of the display 21 or video images and/or to improve, e.g. optimize, the quality of the overall image and/or to improve, e.g. optimize, the efficiency of processing of the image information by a human or machine observer. A few examples are given in FIG. 6 but these examples do not limit the scope of the present invention. The decision on when to scale video signals or not, which particular scaling factor should be used, which particular position each of the video signals should be displayed at, and what the position, shape and pattern of the borders should be, can be dependent on the image contents of one or more video signals being displayed or a combination of one or more of these video signals, the type of images or video being encoded in one or more of the video signals, the particular user that is working with the display 21, the particular application or applications that generate one or more of the video signals, the luminance intensity and colour point of the ambient light in the room, the colour and/or shape of the bezel around the multi-display 21, . . . A specific example could be that according to embodiments of the present invention a display 21 has two separate video inputs: one for receiving a medical video signal, e.g. an X-ray image, and one for receiving a non-medical video signal, e.g. a text file. The display 21 can then be programmed for example to decide autonomously or on demand of the user or on demand of one of more of the applications generating the video data, to display the medical video data in native resolution (since scaling could introduce image artefacts and this is not desirable for high-quality medical video) while at the same time up scaling the non-medical video signal as to use as much of the available display resolution as possible. This situation is shown in configuration (d) of FIG. 6, where 1 represents the medical video data and 2 represents the non-medical video data (such as for example but not limited to a patient record, a workflow list, a report generating application, an email application or other administrative application, . . . ). Other scaling solutions and positioning solutions are shown in other parts of FIG. 6 and are immediately clear for a person skilled in the art, upon viewing them. For example configuration (b) of FIG. 6 shows an input of two images with an aspect ratio such that their width is larger than their height. In such case, the images can automatically be positioned one above the other. Another example is that the decision on whether or not to scale image data depends on the type of medical image (or the type of medical application). For example: if one would display a mammogram image then the general feeling is that scaling is not acceptable and therefore according to embodiments of the present invention this video signal containing a mammogram image would be displayed on the display system or panel 54 in native resolution. On the other hand, if the same video link (the same video signal) would contain a CT image then according to embodiments of the present invention the display 21 would upscale this video signal as to use as much of the available resolution of the display system or panel 54. It is clear for a person skilled in the art that decisions on scaling, positioning of video signals on the active display area, position and/or shape and or pattern of borders can change dynamically. A specific implementation could be that a list of preferred schemes (that describe scaling, positioning of video signals on the active display area, position and/or shape and or pattern of borders) is stored in the display 21 or on the source 14 of input data, e.g. on the PC or on the graphical board 42. The user or alternatively one or more of the applications generating the video data or alternatively any application running at the PC or alternatively any application controlling the display 21 from the PC or remotely (such as but not limited to a QA program) then could select, add, change or remove schemes from this preference list.

Calibration Aspects

The present invention replaces a plurality of displays 11, 12 with a novel display 21 that can simultaneously display all the video sources that were previously sent to this plurality of displays 11, 12. However, this also results in some problems with display calibration that need to be overcome to guarantee the same high quality of the novel display 21 as the original displays 11, 12 had. In the following description often examples will be given where two displays 11, 12 are being replaced by one duo-display 21. However, this does not limit the scope of the present invention: it also possible to replace three, four or more displays by a multi-display 21. Also in the following description the two display systems 11, 12 that are being replaced have specific resolution and colour depth. This also is not a limitation of the present invention: different combinations of different resolutions, aspect ratios, colour depths, refresh rates . . . are possible.

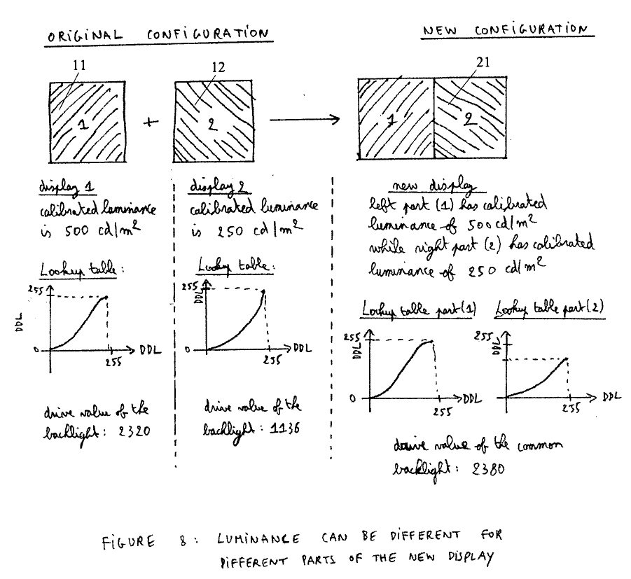

When replacing two or more displays 11, 12 by the multi-display 21 sometimes the displays 11, 12 that are being replaced have different colour point or colour profile. This colour point or colour profile of each of the displays 11, 12 often is intended and even calibrated to a specific colour point or a specific colour profile for example in the case of displays 11, 12 being used for medical imaging. When replacing a plurality of displays 11, 12 by one multi-display 21 it is clear that these calibrated colour points or colour profiles should preferably be retained. Therefore according to embodiments of the present invention different zones of the multi-display 21 (corresponding to different video signals) can have different calibration tables. An example is shown in FIG. 7: two displays 11, 12 are being replaced by one duo-display 21. However, since the two displays 11, 12 were calibrated to a different colour profile, also the duo-display 21 will need to have these same different colour profiles for the corresponding zones of the active display area where video signal 1 and video signal 2 are to be displayed. In practice this would mean that the calibration lookup tables or calibration data of the duo-display 21 can be different for different zones of the active display area. In other words: on the duo-display 21 it is possible and often required to calibrate each “virtual display” (this is a zone of the active display area of the duo-display 21 that corresponds to an active display area of a display 11, 12 that has been replaced) to a different colour point or colour profile.

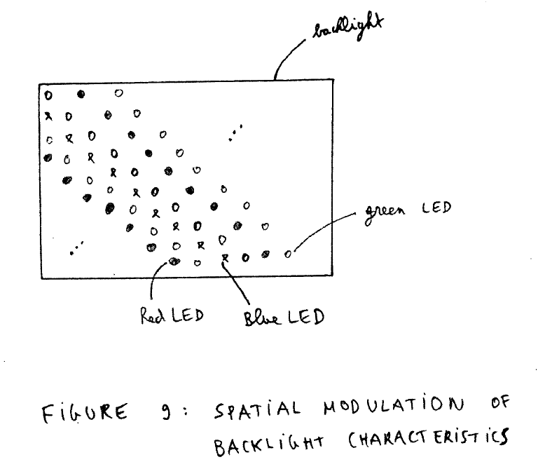

When replacing two displays 11, 12 by one duo-display 21 it is possible that the two displays 11, 12 that have been replaced were calibrated to a different peak luminance level. In medical imaging one typically keeps the peak luminance (the luminance value of full white) stable over the complete lifetime of the display. Typical calibrated luminance values are for example 300 cd/M², 400 cd/m^{2,} 500 cd/m² and 600 cd/M². The choice for a specific calibrated luminance value could depend on the application the display is being used for (in other words on the video contents) or on the user that is using the display. Therefore it is possible that two displays 11, 12 that are being replaced by one single duo-display 21 were calibrated to a different peak luminance value. In such situation of course the peak luminance of the different “virtual displays” (this is a zone of the active display area of the duo-display 21 that corresponds to an active display area of a display 11, 12 that has been replaced) preferably also has the same calibrated peak luminance value as the corresponding displays 11, 12 that were replaced. Typically calibrating to a defined peak luminance value is done by changing the backlight drive value so that full white on the display corresponds to the desired value. In case of a duo-display 21 where there is only one joined backlight for multiple “virtual displays” this is of course not possible. According to embodiments of the present invention the backlight drive value will then be set so that full white on the display 21 corresponds to the virtual display that needs the highest calibrated peak luminance value. The calibrated peak luminance value of the other virtual display(s) will then be guaranteed by changing the lookup table so that flll white for those virtual displays does not correspond to maximum drive level of the panel anymore. In FIG. 8 an example is given of this method. The left hand side of FIG. 8 shows the two displays 11, 12 that will be replaced by one duo-display 21. As an example display 1 could be set to calibrated peak luminance 500 cd/m² while display 2 could be set to calibrated peak luminance 250 cd/M². To comply with these required peak luminance levels both display 1 and display 2 will have a specific setting of the backlight drive value so that full white (maximum video level, in this situation grey level 255) on display 1 will correspond to 500 cd/m² while full white on display 2 will correspond to 250 cd/M². These backlight drive values could for example be 2320 for display 1 and 1136 for display 2. Since normally not only the peak luminance of the display is important but also the shape (and even absolute luminance values) of the transfer curve, both display 1 and display 2 will have a lookup table (inside the display or in the graphical board or in the PC) that make sure that the shape of the transfer curve is as desired. A lookup table is a table that describes how an incoming video level or digital drive level (DDL) should be replaced by another DDL. However as can be seen in the right hand side of FIG. 8, in case of a single display 21 there is only a single backlight that drives both zones of this display 21 (corresponding to respectively the video signal for display 1 and display 2). Therefore one can only set the peak luminance that corresponds to full white (maximum drive level) correctly for one of the two display zones. Indeed, if one would set the backlight drive value so that DDL=255 corresponds to 500 cd/m² then zone 2 of the duo-display will be too bright. If one would set the backlight drive value so that DDL=255 corresponds to 250 cd/m² then zone 1 of the duo-display will be not bright enough. The present invention provides a solution to this problem: one needs to set the drive level of the backlight so that full white (DDL=255 in this case) corresponds to the highest peak luminance of the different zones of the display. In this situation this means that one would have to set the drive level of the backlight so that full white (DDL=255 in this case) corresponds to 500 cd/m². Since now zone 2 of the duo-display 21 will be too bright one will have to change the lookup table of zone 2 of the duo-display 21 so that not only the shape of the transfer curve corresponds to what is desired, but also so that the peak luminance of zone 2 of the display 21 is reduced to 250 cd/m². This can be achieved by completing the lookup table of zone 2 of the duo-display 21 so that incoming DDL value 255 does not correspond anymore to outgoing DDL 255 but to a lower DDL value. Since a lower DDL value corresponds to lower transmittance of the display system 54 this will result in lower peak luminance. In other words: one should select the lookup tables for zone 1 and zone 2 of the duo-display 21 in such a way that both the peak luminance and shape of the transfer curve are correct. This could mean using a different lookup table for different zones of the display 21 where not necessarily the highest value in the lookup table is full white (DDL=255).

In case display 1 and display 2 would have the same peak luminance but another transfer curve then the duo-display 21 can be configured in such a way that also the different zones of the duo-display 21 have a transfer curve corresponding to respectively display 1 and display 2. This can be achieved by assigning a different lookup table to different zones of the duo-display 21. Of course a combination of calibration of colour point or colour profile, calibration of peak luminance value and combination of transfer curve (also called display function) is also possible. Therefore according to embodiments of the present invention the duo-display 21 could have support for one or more of these above items.

It is also possible to replace with a multi-display 21 in accordance with embodiments of the present invention a plurality of displays of which some are monochrome displays and other are colour displays. Of course the different virtual displays of the multi-display 21 then could need different calibration data, different calibration lookup tables, different colour profile, different colour point or different calibrated luminance value. In general one could also make the driving scheme of the display system or panel 54 different for the different zones of the multi-display 21 corresponding to the individual video signals. For example: different zones of the multi-display 21 could have other dithering schemes or different panel inversion schemes. In case of colour sequential displays, zones of the multi-display 21 could be driven in colour sequential mode while other zones could be driven normally (so not as R, G and B sequentially but R, G and B at the same time). In case the multi-display 21 is known to replace a specific plurality of displays one could physically improve, e.g. optimize, the mutli-display 21. For example one could change the display system or panel characteristics of the multi-display 21 spatially. In other words: since one knows in advance which zones of the multi-display 21 will be used to display which specific video signals (each having their own requirements on for example calibration, peak luminance, colour point, colour profile . . . ) one can improve, e.g. optimize, the physical characteristics of the display system or panel 54 to reflect the requirements of the individual video signals as good as possible. A few examples can be: having different black matrix structure for different zones of the multi-display 21, having different colour filters for different zones of the multi-display 21, having no colour filters for some zones of the multi-display 21 (in that case one ends up with a “monochrome” area on the multi-display 21), having other image enhancement foils (such as but not limited to BEF foils, D-BEF foils, viewing angle compensation foils, foils to correct for colour point, foils to correct for luminance, foils to make the display more uniform in brightness and/or luminance . . . ) or in general other optical stack for different zones of the multi-display 21, having some/none or other front-glass or other protective materials at the front side of the display for different zones of the multi-display 21, having some/none or other touch screen for different zones of the multi-display 21, having another backlight for different zones of the multi-display 21, having a modified backlight for some zones of the multi-display 21, or in general having different display panel characteristics for different zones of the multi-display 21 and this to (individually) improve, e.g. optimize, the image quality of the different video signals being displayed on the multi-display 21.

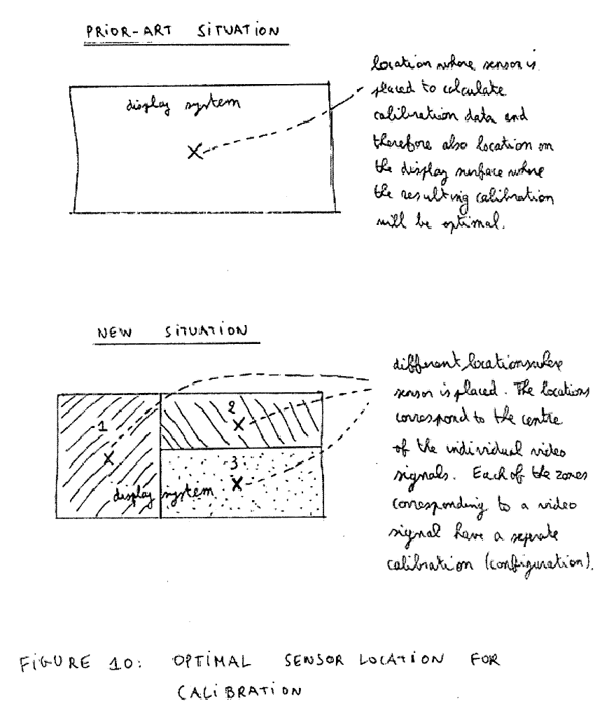

According to another aspect of the present invention the multi-display 21 can have a backlight for which the colour point and/or luminance output can be set differently for different zones of the backlight. In other words: it is possible to set the backlight in such way that different zones of the multi-display 21 will have different luminance output and/or colour point because of the backlight driving/configuration. One example to achieve this is to divide the backlight into elements that can be driven/configured individually. If the elements only (or mainly) locally influence the luminance and/or colour point of the backlight then one has created a backlight for which the luminance output and/or colour point can be modulated spatially over the surface of the backlight. Proper configuration of these backlight elements then allows generating zones of the multi-display 21 that can have different luminance output and/or colour point. A particular implementation of such a backlight could be placing several small light sources for which luminance and/or colour point can be set individually (such as but not limited to white or a combination of red, green and blue LEDs) over the complete area of the backlight. This is shown in FIG. 9: if one would modulate (drive) individually each of the red, green and blue LEDs of the backlight, then it is possible to come up with a backlight that has different characteristics depending on the particular location on the backlight. For example: one could create a zone that is brighter by driving both red, green and blue LEDs brighter in that zone, one could also create (for example) a zone that is more bluish by driving the blue LEDs brighter in a specific zone compared to the red and green LEDs in that zone. It is to be noted that this spatial modulation of backlight characteristics can also be done in combination with techniques to increase the luminance and/or colour uniformity of the complete display 21 (so including the display system or panel 54). Examples of such techniques are electronic pre-correction of the pixel data that is sent to the display system or panel 54, adding of optical compensation foils (to compensate for colour or luminance non uniformity) to the optical stack, shaping the light and/or colour output of the backlight in such a way that this non-uniform output of the backlight will cancel out with the non-uniform behaviour of the display system or panel 54 placed after the backlight . . . and any combination of these mentioned and other techniques. It is also possible to add one or more luminance and/or colour sensors to the backlight (backlight optical sensors, possibly even one colour and/or luminance sensor per light source such as a lamp or LED) or to the front of the multi-display 21. These sensors can be useful in measuring luminance and/or colour point of the display 21 and stabilize luminance and or colour point values to specific values (calibration). Of course it is possible that different zones of the multi-display 21 are being measured with different sensors and/or stabilized to other luminance and/or colour values.

It is possible that the multi-display 21 is programmed to autonomously decide on display parameters such as but not limited to peak luminance, colour point, colour profile, viewing angle behaviour, scaling (native resolution displaying, up scaling or down scaling), lookup table contents, backlight configuration values (possibly driving schemes of individual light sources or groups of light sources), . . . based on the input scan (resolution, bit depth, refresh rate, blanking characteristics, . . . ) or input scans (or even based on the image contents of one or more of the input signals) that are input to the multi-display 21. A particular implementation could be that the multi-display 21 keeps a list of preferred settings (that can be changed) and that the display 21 selects one of those settings based on the characteristics defined above.

In some display systems or panels there are problems with crosstalk. Crosstalk typically is visible as some part of the image that influences another part of the image. One particular example could be if one opens a bright window then lines could appear to the right of that window all the way to the upper right of the display panel. There exist techniques to compensate for crosstalk effects for example by pre-compensating the pixel data sent to the display system or panel so that this pre-compensation cancels out with the crosstalk effects. However, with the multi-display 21 different zones of the display 21 can be representations of different video signals. Therefore these crosstalk compensation algorithms should take into account that image data from other video sources can influence each other. Also the crosstalk compensation algorithms should take into account the exact relative position of the video signals and possible scaling or borders that have been added to the image sent to the display system or panel 54.

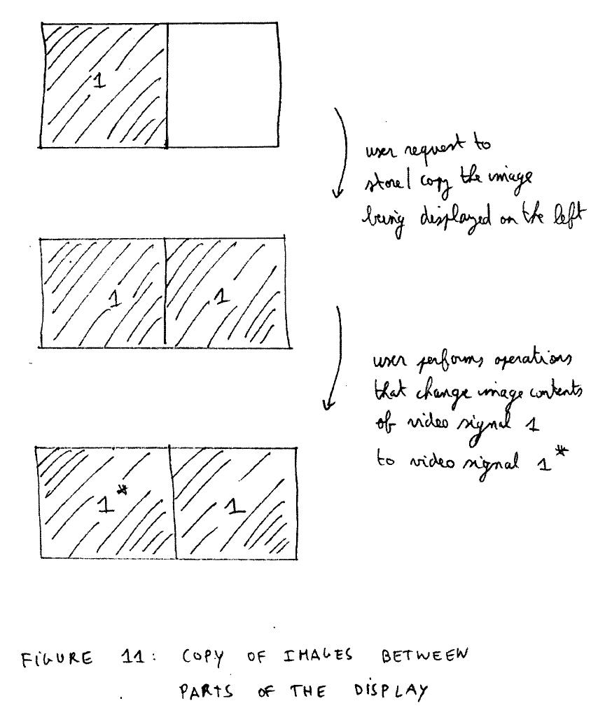

It is known that display systems or panels have non-uniform spatial characteristics. For example: the peak luminance, colour point, colour profile and (native) transfer curve of a display system or panel vary over the display system or panel surface. Common practice up to today when calibrating a display system is to measure the characteristics of the display system (such as colour profile, colour point, peak luminance, native transfer curve) by means of a single sensor placed somewhere on the active display area (mostly in the centre of the display). These measurements then are used to calculate some configuration data so that the display system will be compliant to one or more specific standards. The reason why most of the time the centre location is chosen is because people tend to display the most important data in the centre of the display. Also, typically the centre of the display will have characteristics that are more or less equal to the average (averaged over the complete display surface) characteristics of the display. However, in case of the multi-display in accordance with embodiments of the present invention, we have a display 21 where “centre of the display” does not have a true meaning anymore since multiple video signals will be displayed over the entire active display area. Therefore, according to another aspect of the present invention, the sensor locations to measure the characteristics of the display system may be optimized so that the resulting calibration will be as good as possible. As good as possible also means taking into account that the centre of “virtual displays” should be as well calibrated as possible. This concept is also shown in FIG. 10. The upper part of FIG. 10 is the prior-art situation: a display is characterized with a sensor in the centre of the active display area and this sensor data is used to calibrate the display. Therefore the best calibration is in the centre of the display since there the display characteristics will be correct (because they were measured) while at other locations there could be differences between measured display characteristics and the actual characteristics at that location. If one would apply the same method to the multi-display 21 then it is clear that the calibration would still be optimal in the centre of the display 21 but this is most often not what is desired. What one wants is that the display calibration is optimal in the centre of each of the individual display zones corresponding to individual video signals. According to embodiments of the present invention this problem is solved by carefully selecting the sensor location when measuring the display characteristics and also measuring at multiple locations (as many locations as there are video signals assigned to zones) and use different calibration data for those different zones of the active display area. Of course as a variant one could reduce the number of measurement points/measurements if for instance the zones containing video signals are small and therefore one can assume that the display characteristics of different zones of the display 21 are similar.

Extra Functionality

The present invention also discloses new functionality compared to traditional displays. The new multi-display 21 has the possibility of storing, in a memory, an electronic copy of the display image or part of the display image (for example but not limited to grabbing only the part that corresponds to one of the video signals). It is also possible to store not only a single image but an image sequence at a specific possibly selected frame rate or store an image each time the display contents (or part of the display contents) change. The action of storing an image can be requested by the user of the display 21 for example by means of a button or by means of the OSD (on screen display), alternatively the action of storing an image can be requested by a software application running locally (inside the display 21) or remotely (for example on the PC or somewhere else over the internet), alternatively the action of storing an image could be because of any external trigger. The stored image(s) could be left inside the display 21 inside a volatile or non-volatile memory, alternatively the stored image(s) could be sent to another device such as but not limited to: a PC connected to the display 21, an external memory device connected to the display 21 or the PC, emailed to a recipient, transmitted to any type of devices for example over the internet using a wired or wireless connection, . . . A specific example is that a QA (Quality Assurance) application running remotely over the internet could connect periodically to the display 21 and request to grab an image when a specific test pattern should be visible on the display 21. This image then can be either sent to the QA application or the QA application itself can take the action to get the image from the display 21. The QA application then can examine the image to verify that the display 21 is functioning correctly. Grabbing the image from the display 21 can be done in several ways. For example one could capture the image just before it is sent to the display system or panel 54, in this way one is sure that one captures what is actually sent to the display system or panel 54. One could even place or integrate a (small) camera or other image capture device inside the display 21 so the actual optical image displayed is captured. In this way one is sure that the image is exactly what will be perceived by the user. Grabbing what is sent to the display system or panel 54 is not necessarily what is perceived for example if the display system or panel 54 is defective. Alternatively one could also grab an image at several positions in the image processing pipeline inside the display 21, the graphical board 42 or even the device 14 that is generating the images. By examining and comparing all those images it is possible to find out which particular component of the complete display 21 is defective in case of a malfunction.

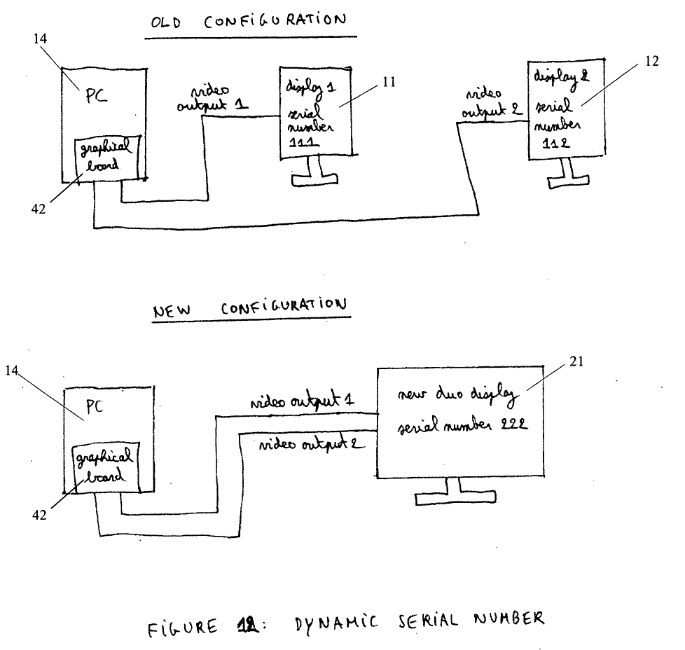

According to another aspect of the present invention it is possible to take a snapshot of zone of the display 21 and copy this to another zone of the display 21 for example for later review. An example is shown in FIG. 11: a multi-display 21 shows one video signal. However, on demand of the user (for instance by means of a button or OSD) or the application or any other device, the image or image sequence being displayed at that time on the left zone of the active display area can be copied to the right zone of the active display area. There that image or image sequence remains available for later review such as comparison with a new image that will be shown on the left of the active display area. A variant is that both zones (left and right) of the active display area show a video signal but that on demand of the user or any application or any device, one or more zones of the images shown on the active display area can be replaced by a previously stored image or image sequence. Of course on demand of the user or any application or any device it should also be possible to in turn replace this previously stored image or image sequence again with the video signal being sent to the display 21

According to another aspect of the present invention the display 21 can have a sensor that detects the orientation of the display 21 (landscape or portrait). The display 21 can be programmed to automatically change the settings of the display 21 if the orientation thereof changes, these setting being such as, but not limited thereto: orientation, position, size, scaling factor of the video signals being displayed on the multi-display; location, size, shape, pattern of the borders (see higher for definition of borders) of the multi-display; any other display settings such as calibration settings, display characteristics (viewing angle behaviour could be changed to again have optimal viewing angle after rotation of the display 21) . . . .

According to another aspect of the present invention the display 21 may provide extra functionality in the border zones of the display 21. As explained before: in some situations a border (a zone of the panel of which the pixels are not driven directly with one or more of the plurality of video signals but for instance driven as completely black or at some grey or colour value) is added to the image being displayed at the multi-display 21. According to embodiments of the present invention one could automatically and dynamically place the OSD (on screen display) at the location of one of the borders so that the OSD does not hide any video signals being displayed. Alternatively one could use the border zones for other input devices such as but not limited to a fingerprint reader, one or more optical sensors measuring luminance and/or colour behaviour of the display system, a touch screen device, . . . Yet another possibility is to display buttons or other control mechanisms in the border zone and use a touch screen to detect the user input. More specifically: one could display in one or more of the border zones some buttons to control brightness, contrast or any other display settings or functionality and detect the user input by means of a touch screen. Possibly but not necessarily this touch screen is only present above the border zones so that image quality is not compromised at locations of the display where no touch screen is needed.

It will be clear for a person skilled in the art, that, wherever the term “duo-display” has been used in the above description, this has been done for the purpose of explanation only, and the more general term “multi-display” might be used.

1. A method for displaying a plurality of input signals on an active display area of a display, the method comprising
splitting the active display area in multiple zones
selecting input signals and assigning these input signals to specific zones of the display, and
simultaneously displaying the selected input signals on the display, each in their assigned zone.

2. A method according to claim 1, furthermore comprising
assigning a border pattern to a specific zone of the active display area,
displaying this border pattern on the active display area in its assigned zone.

3. A method according to claim 2, wherein the border pattern is a fixed pattern.

4. A method according to claim 2, wherein the border pattern is a dynamic pattern depending on the characteristics or image content of the input signal to be displayed in the same zone of the active display area.

5. A method according to claim 2, wherein the border pattern is adapted to the image content to provide improved overall image quality or improved efficiency or performance or work throughput of a user of the display.

6. A method according to claim 1, wherein splitting the active display area in multiple zones comprises selecting a number of zones and a shape of the zones based on characteristics or image contents of the input signals that are to be displayed.

7. A method according to claim 1, wherein selecting input signals and assigning the input signals to specific zones of the active display area comprises optimizing the assigning of input signals in order to obtain improved overall image quality or improved efficiency or improved work throughput of a user of the display.

8. A method according to claim 1, wherein the splitting of the active display area in multiple zones, or the selecting of one of the input signals and assigning the selected input signal to a specific zone of the active display area, or the assigning of a border pattern to a specific zone of the active display area, is being communicated to the display.

9. A method according to claim 1, wherein the splitting of the active display area in multiple zones, or the selecting of one of the input signals and assigning the selected input signal to a specific zone of the active display area, or the assigning of a border pattern to a specific zone of the active display area, is being selected out of a list stored in non-volatile memory.

10. A method according to claim 1, the method furthermore comprising adapting characteristics of individual zones of the active display area in order to improve image quality or user efficiency or user performance or user work throughput.

11. A method according to claim 10, wherein adapting characteristics of individual zones of the active display area in order to improve image quality or user efficiency or user performance or work throughput of the user includes one or more of changing peak luminance, changing colour point, changing colour profile or changing transfer curve of an individual zone of the active display area.

12. A method according to claim 11, wherein adapting characteristics of individual zones of the active display area in order to improve image quality or user efficiency or user performance or work throughput of the user includes performing an individual calibration or using different calibration data for individual zones of the active display area.

13. A method according to claim 12, wherein performing an individual calibration or using different calibration data for individual zones of the active display area includes calibration to DICOM GSDF and using calibration data to comply with DICOM GSDF.

14. A method according to claim 10, wherein preferred characteristics for individual zones of the active display area are being communicated to the display by the user of the display or by any device or software application.

15. A method according to claim 10, wherein preferred characteristics for individual zones of the display are being retrieved from non-volatile memory.

16. A method according to claim 1, the input signals being received from one or more sources of input signal, the method furthermore comprising emulating multiple instances of the display and sending for each zone a different emulated serial number to the one or more sources of input signals.

17. A method according to claim 16, wherein not all of the emulated devices are visible to a source of input signals.

18. A method according to claim 1, wherein displaying a selected input signal on the display comprises scaling, filtering, rotating and/or adapting this input signal.

19. A display adapted for simultaneously displaying a plurality of input signals encoding images in a native resolution, the display comprising:
a plurality of input connectors for simultaneously receiving the plurality of input signals, and
means for simultaneously displaying the encoded images in their native resolution.

20. A display according to claim 19, wherein the display is a LCD display, a CRT display, an OLED display or a plasma display.

21. A display system comprising a display in accordance with claim 19, and at least one image source.

22. Use of a method according to claim 1, in a hospital environment.

23. A control unit for a display for displaying a plurality of input signals on an active display area of the display, the control unit comprising
a splitter for splitting the active display area in multiple zones
a selector for selecting input signals and assigning these input signals to specific zones of the display, and
an image display system for simultaneously displaying the selected input signals on the display, each in their assigned zone.

24. A computer program product enabling a processor to carry out a method as in claim 1.

25. A machine-readable data storage device storing the computer program product of claim 24.

26. Transmission of the computer program product of claim 24, over a local or wide area telecommunications network.
